(19) United States
(12) Patent Application Publication
(10) Pub. No.: US 2025/0309508 A1
(43) Pub. Date: Oct. 2, 2025

(54) INSULATION DEVICE FOR A BATTERY COMPARTMENT, BATTERY COMPARTMENT, ELECTRICAL APPARATUS AND ASSOCIATED ELECTRICAL CIRCUIT BREAKER

(71) Applicant: Schneider Electric Industries SAS, Rueil-Malmaison (FR)

(72) Inventors: Patrick Prieur, Claix (FR); Denis Cancela, St Georges de Commiers (FR)

(73) Assignee: Schneider Electric Industries SAS, Rueil-Malmaison (FR)

(21) Appl. No.: 19/088,192

(22) Filed: Mar. 24, 2025

(30) Foreign Application Priority Data
Mar. 28, 2024 (FR) 2403189

(51) Int. Cl. H01M 50/595; H01B 17/00; H01H 71/02; H01M 10/48; H01M 50/588

(52) U.S. Cl. CPC H01M 50/595; H01B 17/005; H01H 71/0228; H01M 10/488; H01M 50/588

(57) ABSTRACT

This insulation device (250) for a battery compartment (200) comprises a ribbon (260), which extends according to a longitudinal axis (A260) and which comprises a first insulation portion (261), which is electrically insulating, which is continuous along the longitudinal axis (A260), and which is configured to be interposed between a contact terminal (214) and a terminal of an electrical battery (212) in order to prevent the passage of current between the contact terminal and the terminal. The ribbon also comprises a second insulation portion (262) and a conduction portion (263), which is configured not to prevent the passage of current between the terminal and the contact terminal when the conduction portion (263) is interposed between the contact terminal and the terminal. The conduction portion is interposed, according to the longitudinal axis, between the first insulation portion (261) and the second insulation portion (262).

The present invention relates to an insulation device for a battery compartment, a battery compartment comprising such an insulation device, an electrical apparatus comprising such a battery compartment, and an electrical circuit breaker comprising such an electrical apparatus.

This concerns electrical or electronic devices equipped with a battery compartment designed to receive at least one battery used for the operation of the electrical apparatus, in particular when the electronic device is not powered by the electricity grid.

The battery comprises two electrical terminals, while the battery compartment comprises two contact terminals, each configured to press against a respective terminal of the battery when the battery is received in the compartment. The battery is generally inserted into the compartment during the manufacture of the device, so the device is usable as soon as it is put into service. To prevent the battery from being discharged before the device is put into service, it is known to insert an insulation device, in particular a tab made of an insulating material, between one of the battery terminals and the corresponding contact terminal. The insulation device comprises a gripping portion that extends outside the compartment and/or the electrical apparatus. When the electrical apparatus is put into service, the user pulls on the gripping portion to remove the insulation device from the battery compartment, thus bringing the contact terminal and the terminal between which the insulation device was previously interposed into contact.

However, in some applications, it is preferable to check the state of the battery, in particular the charge of the battery, before the electronic device is put into service. Such a situation occurs, for example, when the electronic device is stored between its manufacture and its commissioning. It is then necessary to remove the battery from its compartment, check the battery charge, and then replace the battery in its compartment by reinstalling the insulation device. These operations are impractical and time-consuming.

This invention aims to address these problems more specifically by proposing an insulation device that allows the state of the battery to be checked without having to remove the battery from the compartment.

To this end, the invention relates to an insulation device for a battery compartment, the insulation device comprising:
a ribbon, which extends according to a longitudinal axis, the ribbon presenting a width, measured orthogonally to the longitudinal axis, substantially constant, the ribbon comprising a first insulation portion, which is electrically insulating and continuous along the longitudinal axis,
a gripping portion, which is connected to the ribbon, and which is intended to be grasped by a user in such a way as to pull on the insulation device,
the ribbon is configured to be interposed between a contact terminal of a battery compartment and a respective terminal of a battery received in an internal volume of the battery compartment, a position of the ribbon relative to the battery compartment being adjustable, the first insulation portion being configured to prevent the passage of current between the contact terminal and the terminal when the first insulation portion is interposed between the contact terminal and the terminal,
wherein:
   the ribbon comprises, in addition to the first insulation portion, a second insulation portion and a conduction portion, the conduction portion being interposed, according to the longitudinal axis, between the first insulation portion and the second insulation portion,
   the second insulation portion is electrically insulating and is configured to prevent the passage of current between the contact terminal and the terminal when the second insulation portion is interposed between the contact terminal and the terminal, the insulation device being in a second insulation position,
   the conduction portion is configured not to prevent the passage of current between the terminal and the contact terminal when the conduction portion is interposed between the contact terminal and the terminal, the insulation device being in a conduction position.

Thanks to the invention, when the ribbon is interposed between the contact terminal and the associated electrical terminal, it is possible to displace the insulation device between the insulation positions and the conduction position without completely removing the insulation device, and thus it is possible to test the battery without having to remove it from the compartment. Once the test is completed, the insulation device is returned to one of the insulation positions to prevent the battery from being discharged prematurely.

According to advantageous but non-mandatory aspects of the invention, such a control unit may incorporate one or more of the following features taken individually or in any technically permissible combination:
The conduction portion is a perforated portion.
The ribbon comprises a captive end, by which the ribbon is connected to the rest of the insulation device, and a free end opposite the captive end, while the ribbon comprises, at the free end, a first visual indicator, which is configured to indicate to the user the integrity of the insulation device.
The first insulation portion is arranged between the conduction portion and the gripping portion, while the insulation device includes an intermediate portion, which is interposed between the first insulation portion and the gripping portion according to the longitudinal axis, and the intermediate portion is connected to the first insulation portion by a connection forming a shoulder, which presents a width greater than a width of the ribbon, the shoulder being configured to form a stop against the battery compartment when the insulation device is in the first insulation position.

The invention also relates to a battery compartment, which comprises:
an envelope, which is made of an electrically insulating material, and which delimits an internal volume for receiving an electrical battery,
a contact terminal, which is received in the internal volume, and which is configured to press against a respective terminal of the battery when the battery is received in the internal volume,
one example of the insulation device as described above,
wherein:
   the envelope comprises two notches, through which the internal volume opens onto an external side of the envelope, the two notches being aligned according to a main axis and being configured to allow the passage of the ribbon into the internal volume, the ribbon being inserted simultaneously into the two notches, in an inserted configuration of the ribbon, the ribbon in the inserted configuration being able to slide in the two notches parallel to the main axis so that a longitudinal position of the ribbon relative to the envelope is adjustable,
   when the battery is received in the internal volume and the ribbon is in the inserted configuration, the ribbon is interposed between the contact terminal and the corresponding terminal of the battery,
   when the battery is received in the internal volume and the first insulation portion is interposed between the contact terminal and the corresponding terminal, the passage of current between the terminal and the contact terminal is prevented, the insulation device being in the first insulation position,
   when the battery is received in the internal volume and the second insulation portion is interposed between the contact terminal and the corresponding terminal, the passage of current between the terminal and the contact terminal is prevented, the insulation device being in the second insulation position,
   when the battery is received in the internal volume and the conduction portion is interposed between the contact terminal and the terminal, the passage of current between the terminal and the contact terminal is not prevented, the insulation device being in the conduction position.

### Advantageously:

The ribbon includes at least one visual indicator, which is arranged along the ribbon so as to indicate to the user when the insulation device is in the conduction position.
The at least one visual indicator comprises two visual indicators, which are arranged on either side of the conduction portion, while the two visual indicators are jointly visible outside the envelope when the insulation device is in the conduction position and when the insulation device is in one of the positions from among the first insulation position and the second insulation position, only one of the two visual indicators is visible outside the envelope, the other visual indicator being located inside the envelope.
The at least one visual indicator comprises two visual indicators, which are arranged on the same side of the conduction portion,
wherein when the insulation device is in the conduction position, only one visual indicator is visible outside the envelope, the other visual indicator being located inside the envelope,
wherein the two visual indicators are jointly visible outside the envelope when the insulation device is in the insulation position associated with the insulation portion located on the opposite side of the two visual indicators relative to the conduction portion,
and wherein, when the insulation device is in one of the positions from among the first insulation position and the second insulation position, only one of the two visual indicators is visible outside the envelope, the other visual indicator being located inside the envelope.
The at least one visual indicator comprises two visual indicators, which are arranged on the same side of the conduction portion, while when the insulation device is in the conduction position, only one visual indicator is visible outside the envelope, the other visual indicator being located inside the envelope,
and the two visual indicators are jointly visible outside the envelope when the insulation device is in the insulation position associated with the insulation portion located on the opposite side of the two visual indicators relative to the conduction portion.

The invention also relates to an electrical apparatus, which comprises:
a casing, which is made of an insulating material, and which comprises a housing, the housing forming the envelope of the battery compartment as defined above.

Alternatively, the electrical apparatus comprises:
the battery compartment as defined above,
a casing, which is distinct from the battery compartment, and which provides a housing
for receiving the battery compartment,
wherein, when the battery compartment is received in the housing:
   the notches are located inside the housing,
   the gripping portion is located outside the housing.
   Advantageously, the electrical apparatus is a control unit for an electrical circuit breaker.
The invention also relates to an electrical circuit breaker, which comprises:
   a breaker unit, comprising at least one breaker device and an actuator, the breaker device being triggerable by means of the actuator,
   one example of the control unit such as described above,
wherein:
   the breaker unit provides a receptacle, which opens onto a frontal face of the breaker unit,
   the control unit is received in the receptacle of the breaker unit, so that the gripping portion is accessible from the frontal face of the breaker unit.

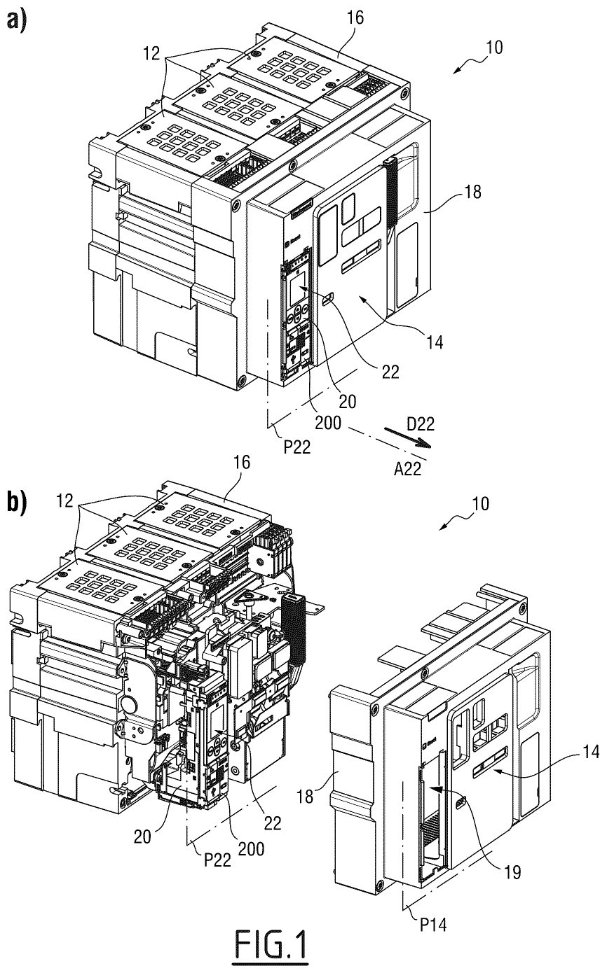

FIG. 1 respectively represents, in two inserts a) and b), a perspective view and a partially exploded perspective view of an electrical circuit breaker in accordance with the invention, the electrical circuit breaker comprising a control unit, also in accordance with the invention;

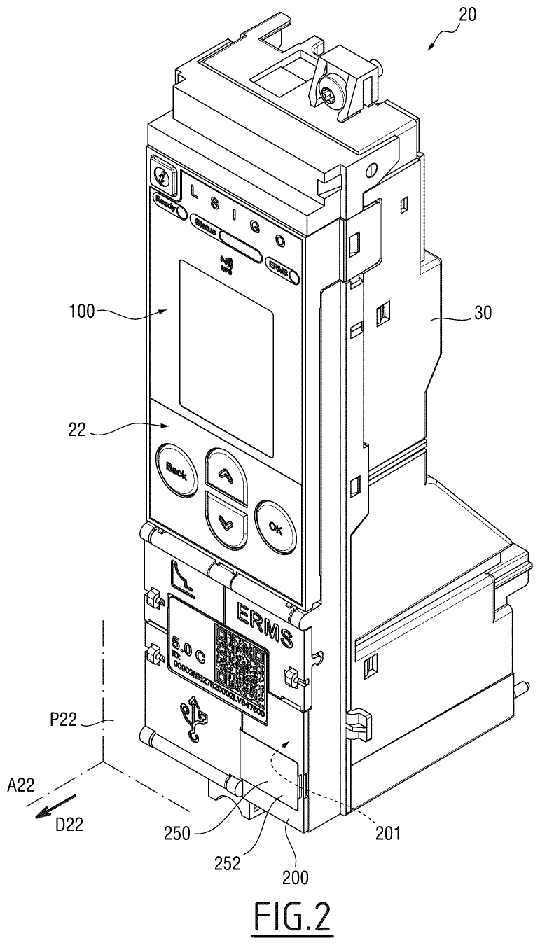

FIG. 2 is a perspective view of the control unit of FIG. 1, the control unit comprising a battery compartment and an insulation device, also in accordance with the invention;

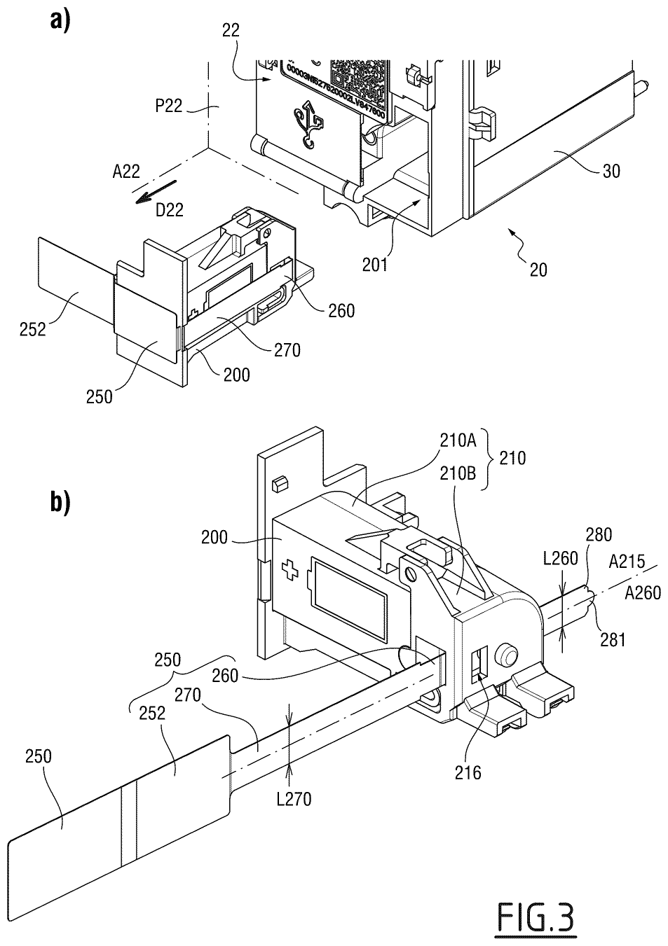

FIG. 3 represents, in two inserts a) and b), a partially exploded perspective view of the control unit of FIG. 2 and a perspective view of the battery compartment and the insulation device;

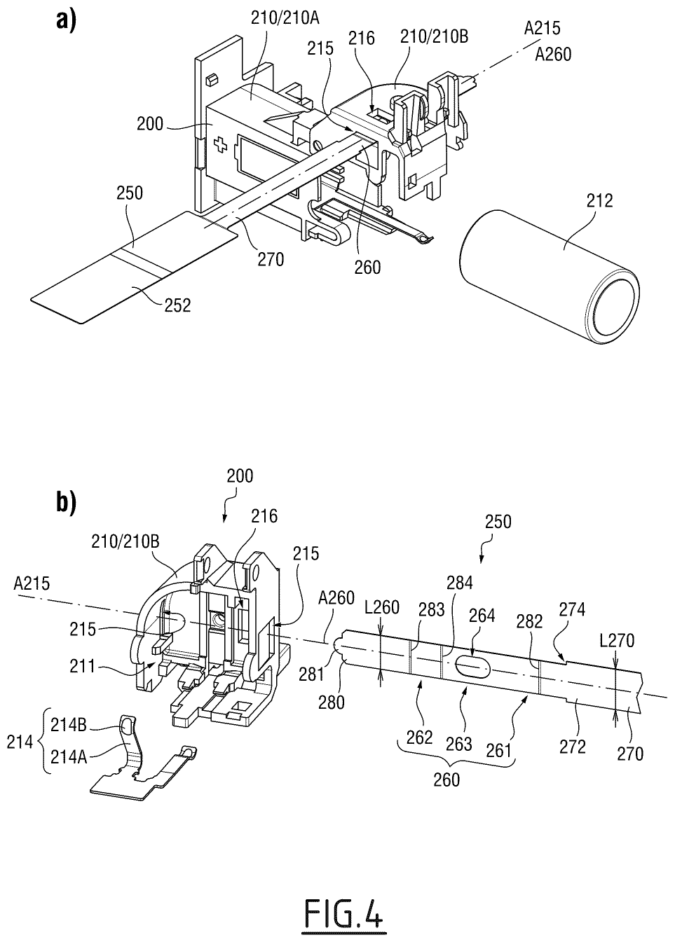

FIG. 4 represents, in two inserts a) and b), a partially exploded perspective view of the battery compartment and the insulation device in two different configurations;

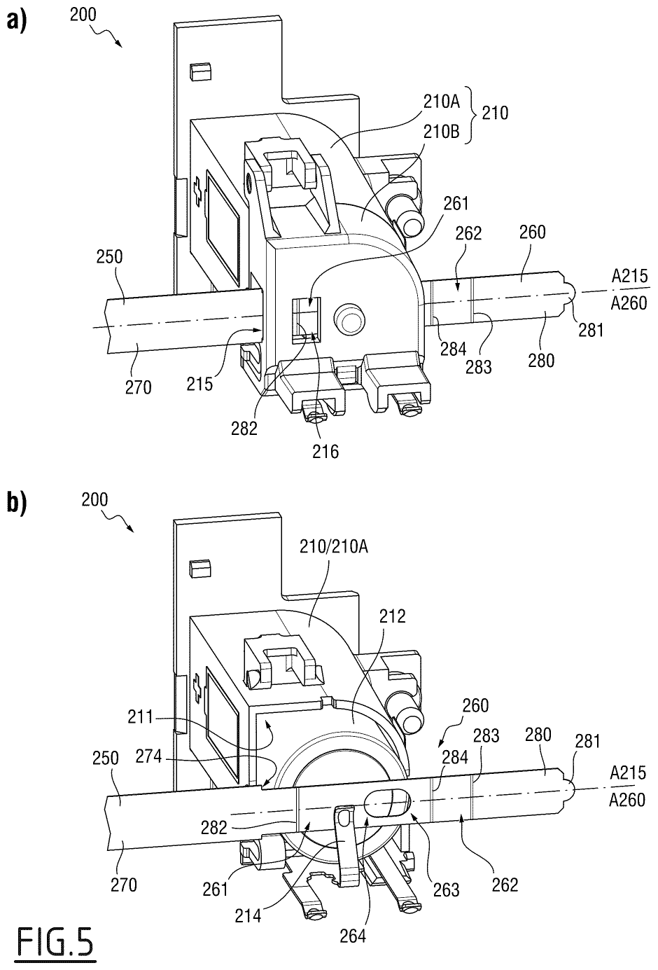

FIG. 5 represents, in two inserts a) and b), a partially exploded perspective view of the battery compartment and the insulation device in a so-called insulation configuration, some parts being hidden in insert b), and

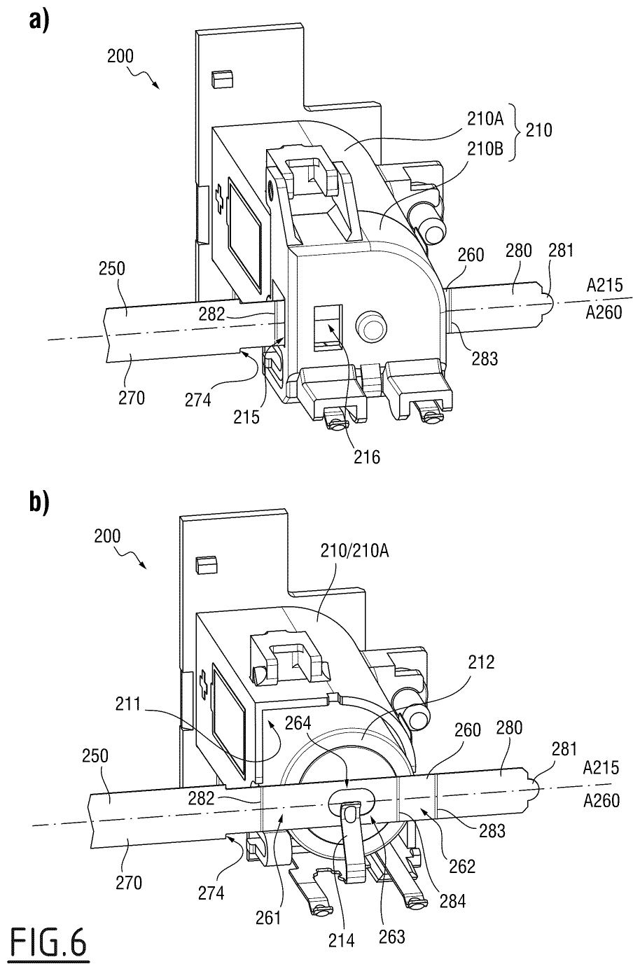

FIG. 6 represents, in two inserts a) and b), a partially exploded perspective view of the battery compartment and the insulation device in a so-called conduction configuration, some parts being hidden in insert b).

An electrical circuit breaker 10 is represented in FIG. 1. The electrical circuit breaker 10, also simply called circuit breaker 10, is here a multipolar circuit breaker, in particular a tripolar circuit breaker. The number of poles of the circuit breaker 10 is not limiting. As is known, a multipolar electrical circuit breaker includes, for each electrical pole, input and output power terminals, which are respectively connected or electrically isolated from each other by a breaker device of the circuit breaker. The breaker device comprises, for example, separable mobile contacts, which are received in a breaker chamber of the electrical circuit breaker 10 and the movements of which are controlled by an actuator. Thus, the breaker device is triggerable by means of the actuator. The breaker chambers are here materialized by three grids 12 visible on an upper face of the circuit breaker 10, the other elements of the breaker device not being represented.

The electrical circuit breaker 10 is intended to be used within an electrical installation, for example, to control the power supply of a machine tool. In a normal configuration of use, the electrical circuit breaker 10 is generally placed within an electrical cabinet, the electrical circuit breaker 10 presenting a frontal face 14, which is oriented toward the user standing in front of the electrical cabinet. The electrical cabinet is not represented.

The electrical circuit breaker 10 comprises a breaker unit 16, which in particular includes each of the breaker chambers, as well as the breaker device and the associated actuator. The electrical circuit breaker 10 advantageously comprises a cover 18, which is reversibly fixed to the breaker unit 16. The cover 18 is made of an electrically insulating material and extends generally according to a frontal plane P14, which defines a portion of the frontal face 14 of the electrical circuit breaker 10, and by extension of the breaker unit 16. The cover 18 thus serves to protect the user of the circuit breaker 10. In FIG. 1 a), the cover 18 is represented assembled to the breaker unit 16, which corresponds to a normal configuration of use of the circuit breaker 10. In FIG. 1 b), the cover 18 is moved away from the breaker unit 16, this configuration being found, for example, during maintenance of the breaker unit 16.

The electrical circuit breaker 10 also comprises a control unit 20. The control unit 20 is configured to analyze one or more states of the breaker unit 16 and is configured to trigger the actuator based on the results of these analyses, thus separating the separable contacts.

The control unit 20 comprises a front face 22, The front face 22 presents a generally flat plane and is geometrically carried by a front plane P22, which is orthogonal to a depth axis A22 of the control unit 20. The front face 22 is oriented toward the user when the control unit 20 is in a normal configuration of use. The front face 22 thus defines a forward direction D22, which is parallel to the depth axis A22. The forward direction D22 is represented by an arrow. The notions of directions such as “forward,” “backward,” “up,” “down,” etc., are defined in relation to the elements as represented in the drawings, knowing that it may be otherwise in reality.

The cover 18 comprises a window 19, through which the front face 22 of the breaker unit 20 is visible. The window 19 is preferably closed by a transparent flap. The flap is not represented.

The control unit 20 is assembled to the breaker unit 16 in a reversible manner. In the example of FIGS. 1a) and 1b), the control unit 20 is represented in an assembled configuration to the breaker unit 16. The control unit 20 is represented separately in FIG. 2.

The breaker unit 16 provides a receptacle, which opens onto a frontal face 14 of the breaker unit 16 and in which the control unit 20 is received, so that the front face 22 of the control unit 20 is substantially aligned with the frontal face 14 of the breaker unit 16, as notably illustrated in FIG. 1 a). The receptacle is not represented.

The control unit 20 is now described, with reference to FIGS. 2 and 3.

The control unit 20 comprises a casing 30, which is made of an insulating material, and which forms a receiving volume for various components of the control unit 20. In the illustrated example, the casing 30 houses an electronics board. The electronics board is not represented. The casing 30 here includes a front sub-assembly 100, which forms a portion of the front face 22.

The control unit 20 also comprises a battery compartment 200, which is received in a housing 201. The battery compartment 200 is configured to receive at least one electric battery. In the illustrated example, the battery compartment 200 receives a single battery 212, here a cylindrical battery. The battery 212 comprises two electrical terminals, which are here arranged on opposite faces of the battery 212. The type of battery and the number of batteries is not limiting for the implementation of the invention. According to the type of battery, the battery 212 presents a voltage of a few Volts between its terminals, typically between 3 V and 24 V.

The casing 30 provides a housing 201 for receiving the battery compartment 200. In the example of FIG. 2, the battery compartment 200 is received in the housing 201, the housing being hidden. In FIG. 3 a), the battery compartment 200 is represented at a distance from the housing 201.

The control unit 20 also comprises an insulation device 250. In FIG. 2, only a gripping portion 252 of the insulation device 250 is visible, the rest of the insulation device 250 being hidden. In FIG. 3 a) and b), the insulation device 250 is represented in two different configurations, respectively a folded configuration and an extended configuration.

The gripping portion 252 is provided to be grasped by a user, in such a way as to pull on the insulation device 250 and separate the insulation device 250 from the battery compartment 200, as explained later.

The gripping portion 252 here presents a generally rectangular shape. The gripping portion 252 is located outside the housing 201 when the battery compartment 200 is received in the housing 201. Advantageously, when the control unit 20 is received in the receptacle of the breaker unit 16, the gripping portion 252 is accessible from the frontal face 14 of the breaker unit 16.

The insulation device 250 is here made entirely of an electrically insulating material, preferably a synthetic polymer material. The insulation device 250 is here made of polycarbonate—noted PC—.

The insulation device 250 is, for example, made by cutting a polymer film, the polymer film having a typically thickness between 100 and 200 μm.

The insulation device 250 is flexible enough to evolve between several configurations, in particular, the folded or extended configurations. The insulation device 250 can thus be folded or extended, preferably by hand and without tools. In the rest of the description, unless specifically mentioned, the insulation device 250 is considered in the extended configuration.

The insulation device 250 comprises, in addition to the gripping portion 252, a ribbon 260, which presents an elongated shape and extends according to a longitudinal axis A260. The ribbon 260 presents a width L260, measured orthogonally to the longitudinal axis A260, which is substantially constant. The width L260 is here equal to 5 mm.

The ribbon 260 comprises three portions, which include a first insulation portion 261, a second insulation portion 262, and a conduction portion 263.

The first insulation portion 261 is electrically insulating and is continuous along the longitudinal axis A260. By “electrically insulating,” it is meant that when two electrodes are placed on either side of the first insulation portion 261, pressing against the ribbon, and a continuous voltage of 24 Volts or less is applied between these two electrodes, no electrical current passes between the two electrodes.

The second insulation portion 262 is electrically insulating and is continuous along the longitudinal axis A260.

The conduction portion 263 is not electrically insulating. In the illustrated example, the conduction portion 263 is made by means of a perforation 264, which is provided through the ribbon 260. The perforation 264 is advantageously located astride the longitudinal axis A260. The conduction portion 263 is thus a perforated portion of the ribbon 260.

In an alternative, not represented, a conductive film is applied to the surface of the ribbon 260, on both sides of the ribbon, to form the conduction portion 263. The conduction portion 263 comprising the perforation 264 is, however, preferred because it is simpler and less costly to implement.

The conduction portion 263 is interposed, according to the longitudinal axis A260, between the first insulation portion 261 and the second insulation portion 262. In the illustrated example, the first insulation portion 161 is arranged between the conduction portion 263 and the gripping portion 252.

The insulation device 250 also comprises an intermediate portion 270, which is interposed between the first insulation portion 161 and the gripping portion 252 according to the longitudinal axis A260. In the illustrated example, the intermediate portion 270 presents a width L270, measured orthogonally to the longitudinal axis A260. The intermediate portion 270 is connected to the first insulation portion 261 by a connection 272 which thus forms a shoulder 274, the width of which L270 is greater than the width L260 of the ribbon 260.

The ribbon 260 comprises a captive end, by which the ribbon is connected to the rest of the insulation device, and a free end 280 opposite the captive end. In the illustrated example, the ribbon 260 is connected to the intermediate portion 270 by means of the captive end. The ribbon 260 comprises, at the free end, a first visual indicator 281, which is provided to confirm to the user the integrity of the insulation device 250. In particular, the first visual indicator 281 is provided to confirm that the insulation device is completely removed from the battery compartment after the user has pulled on the gripping portion 252, and that no piece of the insulation device 250 remains in the battery compartment 200 or in the housing 201 of the control unit 20. The first visual indicator 281 here presents a semicircular shape. Alternatively, and/or in addition, the first visual indicator 281 comprises a zone presenting a different visual appearance from the rest of the ribbon 260. For example, the first visual indicator 281 is red, while the rest of the ribbon 260 is transparent.

The battery compartment 200 is now described.

The battery compartment 200 comprises an envelope 210, which is made of an electrically insulating material, and which delimits an internal volume 211 for receiving the electrical battery 212. The battery compartment 200 also comprises a contact terminal 214, which is received in the internal volume 211 and which is configured to press against a respective terminal of the battery 212 when the battery 212 is received in the internal volume 211. The contact terminal 214 is here a metal blade 214A, which presents an end with a bulge 214B, provided to be pressed against the corresponding terminal.

In the non-limiting illustrated example, the envelope 210 is formed of a first portion 210A closed by a cover 210B, which is pivotally mounted on the first portion 210B and which is intended to hold the battery 212 in the internal volume 211. Other arrangements of the envelope 210 are, of course, possible, for example with a cover screwed to the main portion, or even an envelope 201 made in one piece.

The envelope 210 comprises two notches 215 and 215, through which the internal volume 211 opens onto an external side of the envelope 210, the two notches 215 being aligned according to a main axis A215. When the battery 212 is received in the internal volume 211, it is considered that a contact zone between the contact terminal 214 and the corresponding terminal is located astride the main axis A215.

The notches 215 are configured to allow the passage of the ribbon 260 into the internal volume 211, the ribbon 260 being inserted simultaneously into the two notches 215, in an inserted configuration of the ribbon 260. In the inserted configuration, the longitudinal axis A260 is coincident with the main axis A215. The ribbon 260 in the inserted configuration is able to slide in the two notches 215 parallel to the main axis A215, so that a longitudinal position of the ribbon 260 relative to the envelope 210 is adjustable.

When the battery 212 is received in the internal volume 211 and the first insulation portion 261 is interposed between the contact terminal 214 and the corresponding terminal, the passage of current between the terminal and the contact terminal 214 is prevented, the insulation device 250 being in a first insulation position relative to the envelope 210, as illustrated in FIG. 5.

When the battery 212 is received in the internal volume 211 and the second insulation portion 262 is interposed between the contact terminal 214 and the corresponding terminal, the passage of current between the terminal and the contact terminal 214 is prevented, the insulation device 250 being in a second insulation position relative to the envelope 210.

When the battery 212 is received in the internal volume 211 and the conduction portion 263 is interposed between the contact terminal 214 and the corresponding terminal, the passage of current between the terminal and the contact terminal 214 is not prevented, the insulation device 250 being in a conduction position relative to the envelope 210, as illustrated in FIG. 6.

It is understood that the longitudinal position of the ribbon 260 relative to the envelope 210 in general, and relative to the contact terminal 214 in particular, is adjustable by the user, notably by pulling on the gripping portion 252 or on the free end 280 of the ribbon 260. When the user pulls on the gripping portion 252, the ribbon 260 displaces relative to the envelope 210 according to a withdrawal direction, whereas when the user pulls on the free end 280, the ribbon 260 displaces relative to the envelope 210 in an insertion direction, which is opposite to the withdrawal direction.

Advantageously, the shoulder 274 is configured to form a stop against the envelope 210 when the insulation device 250 is in the first insulation position. In other words, the shoulder 274 cooperates with the envelope 210 in such a way as to limit the displacement of the ribbon according to the insertion direction. In corollary, when the shoulder 274 is in abutment against the envelope 210, the user knows that the insulation device 250 is in the first insulation position.

Advantageously, the ribbon 260 comprises at least one visual indicator, which is arranged along the ribbon 260 in such a way as to indicate to the user when the insulation device 250 is in the conduction position. The at least one visual indicator comprises two visual indicators 282 and 283, which are arranged on either side of the conduction portion 263, the two visual indicators 282 and 283 being jointly visible outside the envelope 210 when the insulation device 250 is in the conduction position, as illustrated in FIG. 6 a). Thus, the user, seeing the two visual indicators 282 and 283 outside the envelope 210, obtains confirmation that the perforation 264 is aligned with the contact terminal 214. In the illustrated example, the two visual indicators 282 and 283 are formed by colored lines arranged on the ribbon 260, the rest of the ribbon 260 being transparent. Alternatively, an entire zone between the two visual indicators 282 and 283 is colored, the rest of the ribbon 260 being transparent.

Advantageously, the envelope 210 comprises an opening 216, which is arranged radially to the main axis A215 and through which the internal volume 211 opens to the outside of the envelope 211, one of the visual indicators, here the visual indicator 282, being visible through the opening 216 when the insulation device is in one of the insulation positions, here the first insulation position, as illustrated in FIG. 5 a).

Advantageously, the ribbon 260 comprises, in addition to the visual indicator 283 located between the conduction portion 263 and the free end 280, another visual indicator 284, which is interposed between the visual indicator 283 and the conduction portion 263. In other words, the ribbon 260 comprises two visual indicators that are located on the same side of the conduction portion 263 according to the longitudinal axis A260. The two visual indicators 283/284 are here located between the conduction portion 263 and the free end 280, in other words, on the side of the second insulation portion 262.

When the insulation device 250 is in the first insulation position, the two visual indicators 283 and 284 are visible outside the envelope 210, as represented in FIG. 5. When the insulation device 250 is in the first conduction position, as represented in FIG. 6, only one of the two visual indicators—here the indicator 283—is visible outside the envelope 210, the other visual indicator—here the visual indicator 284—being hidden inside the envelope 210. Each visual indicator 283 or 284 is thus respectively associated with a position from among the conduction position and the first insulation position.

In an alternative, not represented, a mirror arrangement is, of course, possible, in other words, the ribbon comprises, in addition to the visual indicator 282 located between the conduction portion 263 and the gripping portion 252, another visual indicator, which is interposed between the conduction portion 263 and the visual indicator 282. When the insulation device 250 is in the second insulation position, the two visual indicators are visible outside the envelope 210. When the insulation device 250 is in the conduction position, only one of the two visual indicators—here the visual indicator 282—is visible outside the envelope 210, the other visual indicator being hidden inside the envelope 210.

More generally, the insulation device 250 comprises two visual indicators, which are arranged on the same side of the conduction portion 263. When the insulation device 250 is in the conduction position, only one visual indicator 283 is visible outside the envelope 210, the other visual indicator 284 being located inside the envelope. The two visual indicators 283, 284 are jointly visible outside the envelope 210 when the insulation device 250 is in the insulation position associated with the insulation portion located on the opposite side of the two visual indicators relative to the conduction portion 263.

In the illustrated example, the two visual indicators 283 and 284 are colored bands. As an alternative, not represented but nevertheless advantageous, the two visual indicators are two arrows, which are aligned on the longitudinal axis A260, and which are oriented toward the conduction portion 263. When the insulation device 250 is in one of the positions from among the conduction position and the first insulation position, a tip of the corresponding arrow is substantially aligned on the closest notch 215.

In the illustrated example, the control unit 20 is an example of an electrical apparatus, which provides the housing for receiving the battery compartment which is received in the housing. Of course, the principles of the invention are transposable to other types of electrical apparatus.

In the illustrated example, the battery compartment is distinct from the casing of the electrical apparatus, here the control unit 20. In an alternative, not represented, the battery compartment is formed by a recess provided directly in the casing of the electrical apparatus.

The embodiments and alternatives mentioned above can be combined with each other to generate new embodiments of the invention.

1. An insulation device for a battery compartment, the insulation device comprising:
a ribbon, which extends according to a longitudinal axis, the ribbon presenting a width, measured orthogonally to the longitudinal axis, that is constant, the ribbon comprising a first insulation portion, which is electrically insulating and continuous along the longitudinal axis,
a gripping portion, which is connected to the ribbon and is provided to be grasped by a user in such a way as to pull on the insulation device,
the ribbon is configured to be interposed between a contact terminal of the battery compartment and a respective terminal of a battery received in an internal volume of the battery compartment, a position of the ribbon relative to the battery compartment being adjustable, the first insulation portion being configured to prevent the passage of current between the contact terminal and the terminal when the first insulation portion is interposed between the contact terminal and the terminal,
wherein:
the ribbon comprises, in addition to the first insulation portion, a second insulation portion and a conduction portion, the conduction portion being interposed, according to the longitudinal axis, between the first insulation portion and the second insulation portion,
the second insulation portion is electrically insulating and is configured to prevent the passage of current between the contact terminal and the terminal when the second insulation portion is interposed between the contact terminal and the terminal, the insulation device being in a second insulation position,
the conduction portion is configured not to prevent the passage of current between the terminal and the contact terminal when the conduction portion is interposed between the contact terminal and the terminal, the insulation device being in a conduction position.

2. The insulation device according to claim 1, wherein:
the conduction portion is a perforated portion.

3. The insulation device according to claim 1, wherein:
the ribbon comprises a captive end, by which the ribbon is connected to the rest of the insulation device, and a free end opposite the captive end,
the ribbon comprises, at the free end, a first visual indicator, which is configured to indicate to the user the integrity of the insulation device.

4. The insulation device according to claim 1, wherein:
the first insulation portion is arranged between the conduction portion and the gripping portion,
the insulation device comprises an intermediate portion, which is interposed between the first insulation portion and the gripping portion according to the longitudinal axis,
the intermediate portion is connected to the first insulation portion by a connection forming a shoulder, which presents a width greater than a width of the ribbon, the shoulder being configured to form a stop against the battery compartment when the insulation device is in the first insulation position.

5. A battery compartment, comprising:
an envelope, which is made of an electrically insulating material, and which delimits an internal volume for receiving an electrical battery,
a contact terminal, which is received in the internal volume, and which is configured to press against a respective terminal of the battery when the battery is received in the internal volume,
an example of the insulation device according to claim 1,
wherein:
the envelope comprises two notches, through which the internal volume opens onto an external side of the envelope, the two notches being aligned according to a main axis and being configured to allow the passage of the ribbon into the internal volume, the ribbon being inserted simultaneously into the two notches, in an inserted configuration of the ribbon, the ribbon in the inserted configuration being able to slide in the two notches parallel to the main axis so that a longitudinal position of the ribbon relative to the envelope is adjustable,
when the battery is received in the internal volume and the ribbon is in the inserted configuration, the ribbon is interposed between the contact terminal and the corresponding terminal of the battery,
when the battery is received in the internal volume and the first insulation portion is interposed between the contact terminal and the corresponding terminal, the passage of current between the terminal and the contact terminal is prevented, the insulation device being in the first insulation position,
when the battery is received in the internal volume and the second insulation portion is interposed between the contact terminal and the corresponding terminal, the passage of current between the terminal and the contact terminal is prevented, the insulation device being in the second insulation position,
when the battery is received in the internal volume and the conduction portion is interposed between the contact terminal and the terminal, the passage of current between the terminal and the contact terminal is not prevented, the insulation device being in the conduction position.

6. The battery compartment according to claim 5, wherein:
the ribbon comprises at least one visual indicator, which is arranged along the ribbon in such a way as to indicate to the user when the insulation device is in the conduction position.

7. The battery compartment according to claim 6, wherein:
the at least one visual indicator comprises two visual indicators, which are arranged on either side of the conduction portion,
the two visual indicators are jointly visible outside the envelope when the insulation device is in the conduction position,
when the insulation device is in one of the positions from among the first insulation position and the second insulation position, only one of the two visual indicators is visible outside the envelope, the other visual indicator being located inside the envelope.

8. The battery compartment according to claim 6, wherein:
the at least one visual indicator comprises two visual indicators, which are arranged on the same side of the conduction portion,
when the insulation device is in the conduction position, only one visual indicator is visible outside the envelope, the other visual indicator being located inside the envelope,
the two visual indicators are jointly visible outside the envelope when the insulation device is in the insulation position associated with the insulation portion located on the opposite side of the two visual indicators relative to the conduction portion.

9. An electrical apparatus, comprising:
a casing, which is made of an insulating material, and which comprises a housing, the housing forming the envelope of the battery compartment according to claim 5.

10. An electrical apparatus, comprising:
the battery compartment according to claim 5,
a casing, which is distinct from the battery compartment, and which provides a housing for receiving the battery compartment,
wherein, when the battery compartment is received in the housing:
the notches are located inside the housing,
the gripping portion is located outside the housing.

11. The electrical apparatus according to claim 10, wherein:
the electrical apparatus is a control unit for an electrical circuit breaker.

12. An electrical circuit breaker, comprising:
a breaker unit, comprising at least one breaker device and an actuator, the breaker device being triggerable by means of the actuator,
one example of the control unit according to claim 11,
wherein:
the breaker unit provides a receptacle, which opens onto a frontal face of the breaker unit,
the control unit is received in the receptacle of the breaker unit, so that the gripping portion is accessible from the frontal face of the breaker unit.
